(19) United States
(12) Patent Application Publication
(10) Pub. No.: US 2026/0063202 A1
(43) Pub. Date: Mar. 5, 2026

(54) CAMSHAFT ASSEMBLY FOR GEAR SWITCHING APPARATUS OF VEHICLE

(71) Applicant: NEW KAILUNG GEAR CO, LTD., KAOHSIUNG (TW)

(72) Inventor: JEN-CHIH LIU, KAOHSIUNG (TW)

(73) Assignee: NEW KAILUNG GEAR CO., LTD., KAOHSIUNG (TW)

(21) Appl. No.: 18/818,646

(22) Filed: Aug. 29, 2024

(51) Int. Cl. F16H 63/18; F16H 63/32

(52) U.S. Cl. CPC F16H 63/18; F16H 63/32; F16H 2063/321

(57) ABSTRACT

A camshaft assembly for a gear switching apparatus of a vehicle includes a driving shaft capable of being electrically or manually driven to be rotated. A first spring adapting plate and at least one cam installed on the driving shaft. A fork shift guiding recess formed on a surface of each of the at least one cam. At least one shift fork connected to the at least one cam. A cushioning device installed between the driving shaft and the at least one cam. When the driving shaft is rotated to perform a gear switching and the at least one shift fork is in a gear misaligned state, the cushioning device provides a cushioning to cause that the at least one cam and first spring adapting plate generate a cushioning force for performing a gear alignment operating of the at least one shift fork.

### FIELD OF THE INVENTION

The present invention is related to a gear switching apparatus, and in particular to a camshaft assembly for a gear switching apparatus of a vehicle. The camshaft assembly of the present invention serves to avoid a gear disposition and automatically complete a gear aligning engagement and a gear cushioning switching of at least one cam and at least one shift fork by using a single cushioning device.

### BACKGROUND OF THE INVENTION

The structure of the gear switching apparatus of the vehicle in the prior arts is shown in FIGS. 1 to 2, wherein a box cover body A including a gear switching apparatus A1 and a gear switching control device A2 which is controlled by a gear switching operation for controlling the gear switching apparatus A1. The gear switching control device A2 is connected to a camshaft assembly A3, as shown in FIG. 3. The camshaft assembly A3 includes a camshaft A4, two cams A41 A42, a first cushioning spring A43 to control each of the two cams A41 A42, a fork shift shaft A44, two shift forks A45 installed on the fork shift shaft A44, and two second cushioning springs A46 installed on the fork shift shaft A44 to provide a cushioning for the two shift forks A45.

Above structure has the following features and disadvantages:
(1) Referring to the prior art in FIG. 3, each of the two cams A41, A42 is formed by two sub cams. The cam A41 is formed by two sub cams A411, A412 which are connected to each other. The cam A42 is formed by two sub cams A421, A422 which are connected to each other.

However, above structure of the cams A41, A42 of the prior arts is complicated, which causes high costs and troublesome assembling. It further has a serious disadvantage that when the vehicle is in a parking gear position state, due to the slope of the ground where the vehicle is parked and the weight thrust generated by the vehicle tending to slide, a reaction force will be generated by the shift forks A45 to be applied to the respective cam A41 or cam A42. Since each of the two cams A41, A42 is formed by two sub cams which are connected to each other and the cushioning for the two cams A41, A42 is provided by the first cushioning spring A43, when the reaction force is applied to the respective cam A41 or the cam A42, the two sub cams of the respective cam A41 or cam A42 will be easily separated from each other to cause the shift forks A45 to be in a gear disposition state. Therefore, a serious danger of the vehicle self-slippage will occur.
(2) Referring to the prior art in FIG. 3, the two shift forks A45 are controlled by the two cams A41, A42. Two second cushioning springs A46 are installed on the fork shift shaft A44 which is serially connected to the two shift forks A45. Each of the two second cushioning springs A46 serve to provide a cushioning during the gear misaligned state of the respective shift fork A45.

However, above structure is also very complicated, which has the disadvantages of high costs, troublesome assembling, large component size, increased weight and increased operating load.

### SUMMARY OF THE INVENTION

Accordingly, the object of the present invention is to provide a camshaft assembly for a gear switching apparatus of a vehicle. The present invention has the following advantages:
(1) The present invention provides at least one cam for controlling the shifting of at least one shift fork. The cam has a fork shift guiding recess having a fixed inner width for guiding the respective shift fork to avoid the gear disposition during the shifting of the fork shift and to eliminate the serious danger of the vehicle sliding on its own due to forceful gear disposition.
(2) The present invention provides the at least one cam which is engaged to each other and is not opened or closed. The cam is connected to a single cushioning device which serves to provide a cushioning performance during the gear misaligned state of the shift fork. The design of using one single cushioning device reduces the complexity of the cushioning function and solves the disadvantage of the prior cushioning device using a complex design of multiple cushioning springs.
(3) The present invention provides the at least one cam which is engaged to and spaced apart from each other and is not opened or closed. The cushioning device is installed between two cams and has a connecting ring engaged between the two cams, which provides a cushioning function during the gear misaligned state of the shift fork and solves the disadvantage of the prior cushioning device using a complex design of multiple cushioning springs.
(4) The present invention provides a camshaft assembly for the gear switching apparatus of the vehicle with a simple structure, fewer components, a low cost, a compact size and a good practicability.
(5) The present invention provides a camshaft assembly for the gear switching apparatus of the vehicle with a high safety, a high practicality, a high industrial utilization and a high economically efficiency.

To achieve above object, the present invention provides a camshaft assembly for a gear switching apparatus of a vehicle comprising: a driving shaft capable of being electrically or manually driven to be rotated; a first spring adapting plate integrated on the driving shaft; at least one cam installed on the driving shaft; a fork shift guiding recess formed on a surface of each of the at least one cam and having a single fixed inner width; the fork shift guiding recess serving to guide the at least one shift fork to avoid a gear disposition of the gear switching apparatus; at least one shift fork connected to the at least one cam; a cushioning device installed between the driving shaft and the at least one cam; and wherein when the driving shaft is rotated forward or reversely to perform a gear switching and the at least one shift fork is in a gear misaligned state during a shifting of the at least one shift fork, the cushioning device serves to provide a cushioning to cause that the at least one cam and first spring adapting plate generate a cushioning force for performing a gear alignment operating of the at least one shift fork, which achieves an auto gear aligning engagement and a gear cushioning switching on the at least one cam and the at least one shift fork to avoid the gear disposition of the gear switching apparatus.

In a first embodiment of the present invention, the at least one cam includes a first cam and a second cam which are serially connected to each other; the cushioning device is connected to a lower end of the first cam; and an upper end of the first cam is engaged to a lower end of the second cam.

In a second embodiment of the present invention, the at least one cam includes a first cam and a second cam; the cushioning device includes a connecting ring connected between the first cam and the second cam; and the driving shaft serves to drive the cushioning device and the connecting ring.

In a third embodiment of the present invention, the at least one cam includes a first cam connected to the respective shift fork; and the cushioning device is installed between the first cam and the driving shaft.

### BRIEF DESCRIPTION OF THE DRAWINGS

FIG. 1 is a schematic view of the gear switching apparatus of the prior art.

FIG. 2 is an exploded schematic view of the gear switching apparatus of the prior art.

FIG. 3 is an exploded schematic view of the camshaft assembly of the gear switching apparatus of the prior art.

FIG. 4 is an exploded schematic view of the main elements of the first embodiment of the present invention.

FIG. 5 is an exploded schematic view of the first embodiment of the present invention.

FIG. 6 is a cross sectional view of the first embodiment of the present invention.

FIG. 7 is an exploded schematic view of the second embodiment of the present invention.

FIG. 8 is a cross sectional view of the second embodiment of the present invention.

FIG. 9 is an exploded schematic view of the third embodiment of the present invention.

FIG. 10 is a cross sectional view of the third embodiment of the present invention.

FIG. 11 is a schematic view of the second cam of the first embodiment of the present invention.

FIG. 11-1 is a linear expanded schematic view of the second cam in FIG. 11.

FIG. 12 is another schematic view of the second cam of the first embodiment of the present invention.

FIG. 13 is a top plane view of the second cam in FIG. 12.

FIG. 14 is a right side view of the second cam in FIG. 12.

FIG. 15 is a left side view of the second cam in FIG. 12.

FIG. 16 is a schematic view of the first cam of the first embodiment of the present invention.

FIG. 16-1 is a linear expanded schematic view of the first cam in FIG. 11.

FIG. 17 is another schematic view of the first cam of the first embodiment of the present invention.

FIG. 18 is a top plane view of the first cam in FIG. 17.

FIG. 19 is a right side view of the first cam in FIG. 17.

FIG. 20 is a left side view of the first cam in FIG. 17.

FIG. 21 is a schematic view of the first cam of the second embodiment of the present invention.

FIG. 22 is another schematic view of the first cam of the second embodiment of the present invention.

FIG. 23 is a right side view of the first cam in FIG. 22.

FIG. 24 is a left side view of the first cam in FIG. 22.

FIG. 25 is a schematic view of the second cam of the second embodiment of the present invention.

FIG. 26 is another schematic view of the second cam of the second embodiment of the present invention.

FIG. 27 is a right side view of the second cam in FIG. 26.

FIG. 28 is a left side view of the second cam in FIG. 26.

FIG. 29 is a schematic view of the first cam of the third embodiment of the present invention.

FIG. 30 is another schematic view of the first cam of the third embodiment of the present invention.

FIG. 31 is a top plane view of the first cam in FIG. 30.

FIG. 32 is a right view of the first cam in FIG. 30.

FIG. 33 is a left view of the first cam in FIG. 30.

FIG. 34 is an exploded schematic view of the spring supporting ring, the spring cover and a positioning ring of the first and third embodiment of the present invention.

FIG. 35 is schematic view showing the assembling of the first cam and the driving shaft of the third embodiment of the present invention.

FIG. 36 is an assembled view of the third embodiment of the present invention.

FIG. 37 is schematic view showing the assembling of the first cam, second cam and the connecting ring of the second embodiment of the present invention.

FIG. 38 is schematic view of the connecting ring of the second embodiment of the present invention.

FIG. 38 is another schematic view of the connecting ring of the second embodiment of the present invention.

FIG. 40 is schematic view showing the assembling of the second embodiment of the present invention.

FIG. 41 is another cross sectional view of the second embodiment of the present invention.

FIG. 42 is schematic view showing a switching angle of the gear switching in the first and second embodiment of the present invention.

FIG. 43 is a schematic section view showing the driving shaft is switched from a neutral (N) gear positon to a high (H) gear position in the second embodiment of the present invention.

FIG. 44 is a schematic section view showing the driving shaft is switched from a neutral (N) gear positon to a reverse (R) gear position in the second embodiment of the present invention.

FIG. 45 is another cross sectional view of the third embodiment of the present invention.

FIG. 46 is schematic view showing a switching angle of the gear switching in the third embodiment of the present invention.

FIG. 47 is a schematic section view showing the driving shaft is switched from a neutral (N) gear positon to a high (H) gear position in the first and third embodiment of the present invention.

FIG. 48 is a schematic section view showing the driving shaft is switched from a neutral (N) gear positon to a low (L) gear position in the first and third embodiment of the present invention.

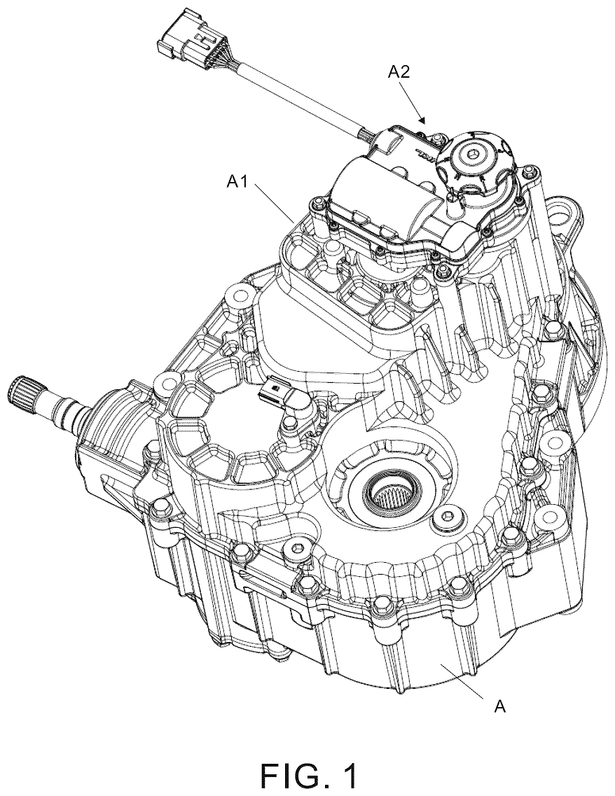

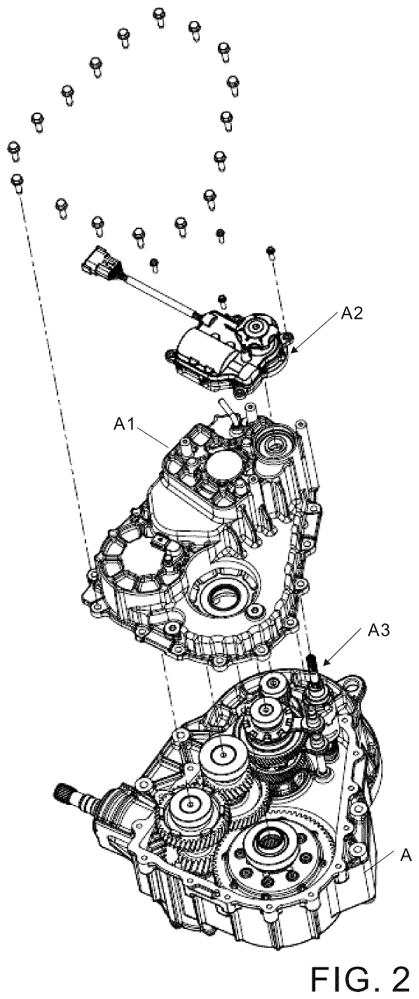

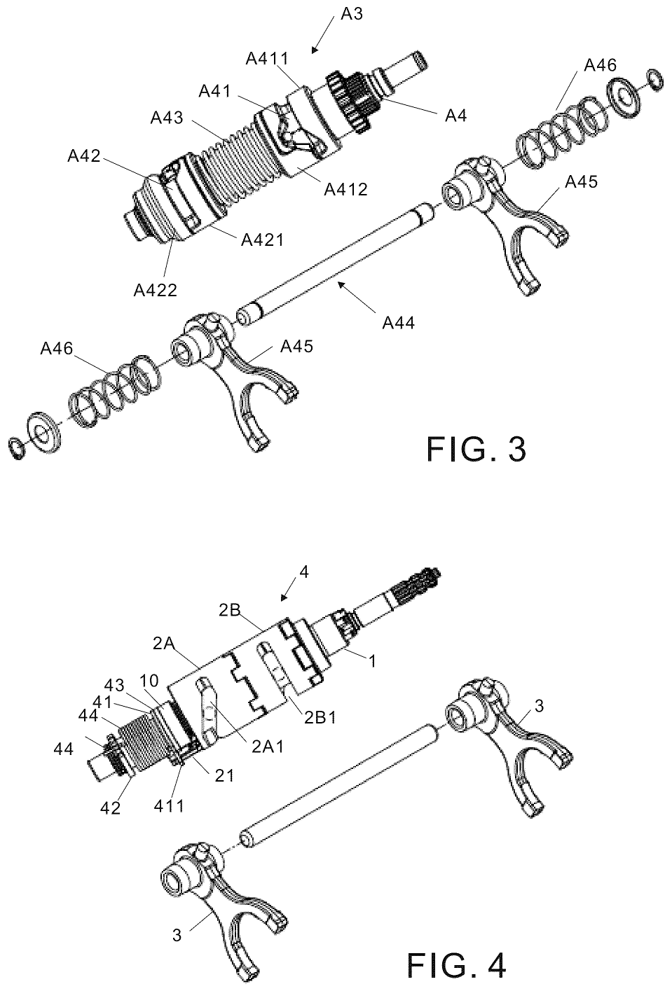

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

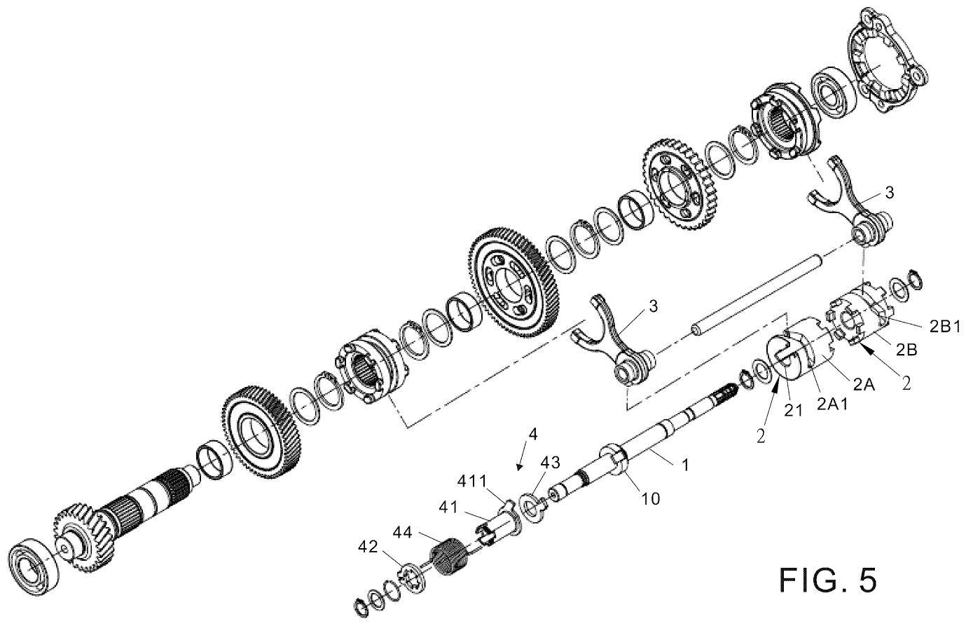

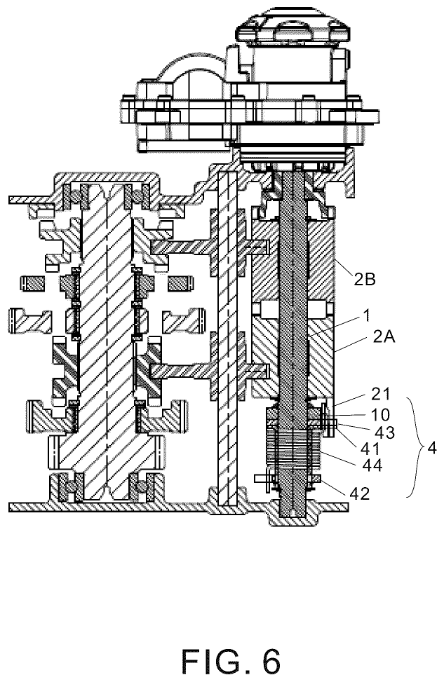

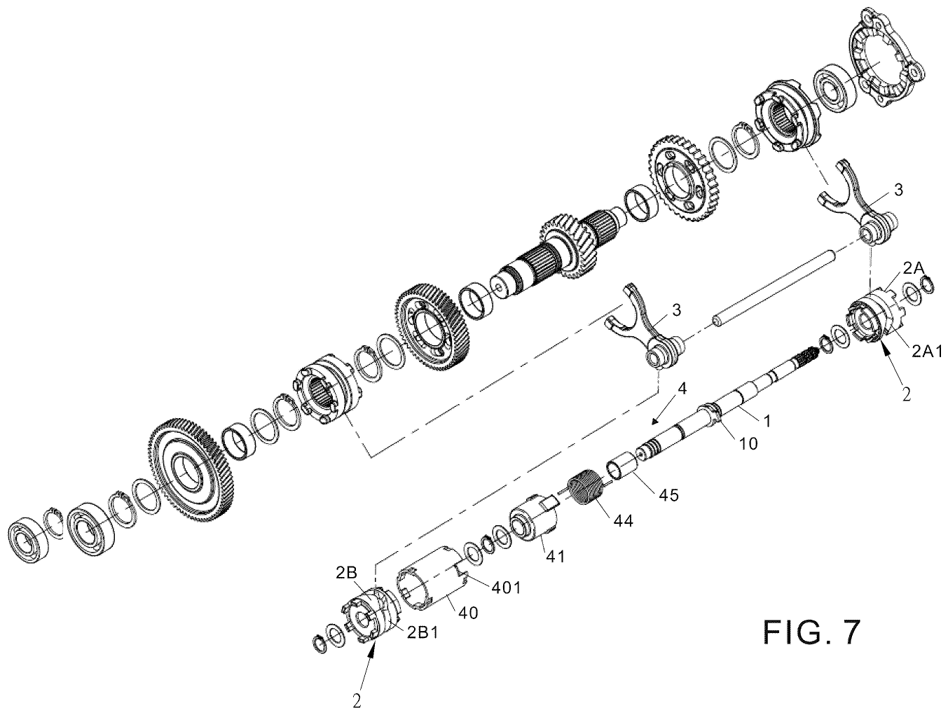

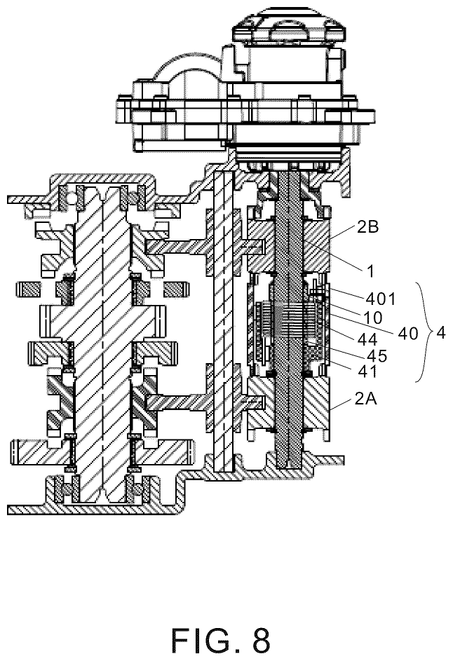

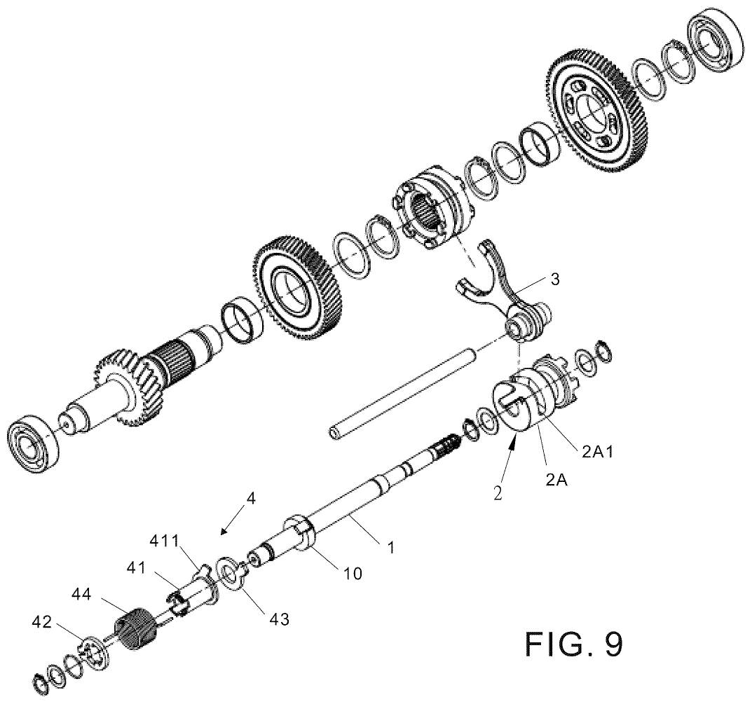

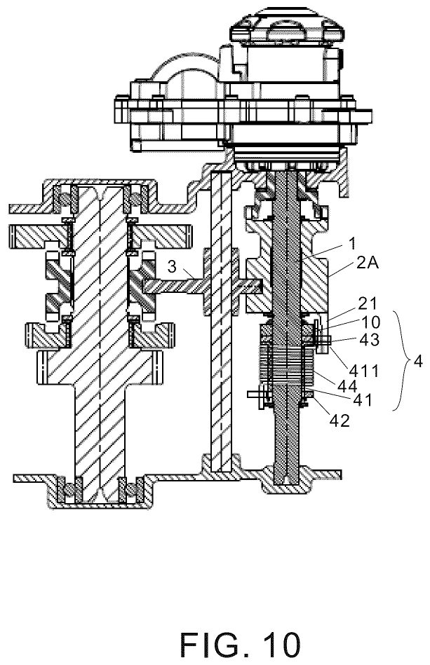

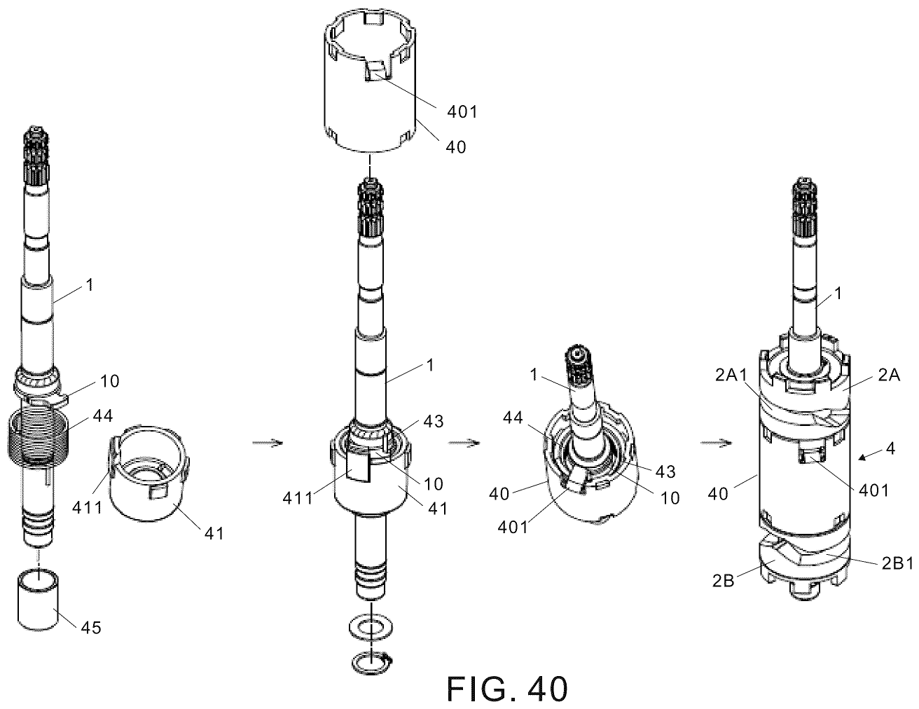

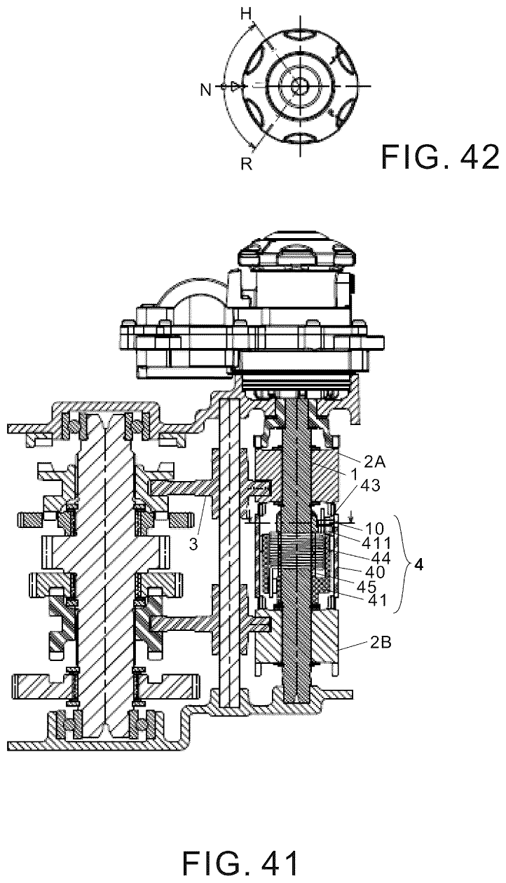

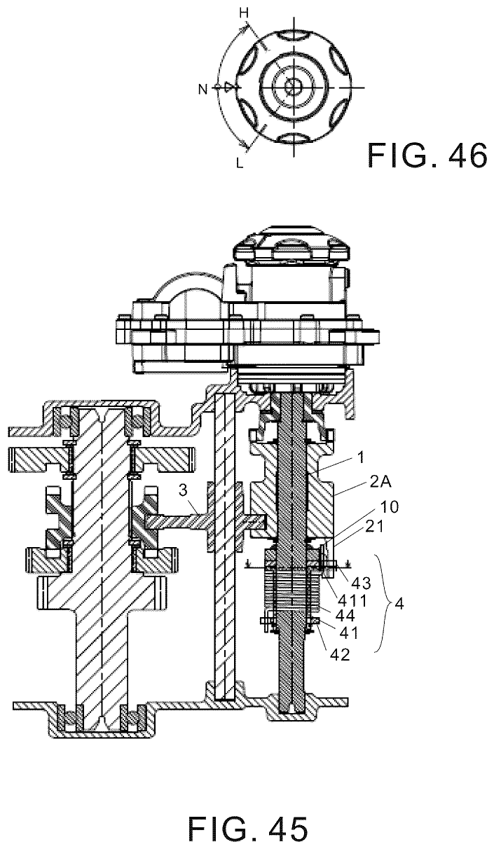

With reference to FIGS. 4 to 48, the present invention provides a camshaft assembly for a gear switching apparatus of a vehicle. FIGS. 4 to 6 show the first embodiment of the present invention. FIGS. 7 to 8 show the second embodiment of the present invention. FIGS. 9 to 10 show the third embodiment of the present invention.

The first, second and third embodiment have same main features and have a same design motivation, effect, application value, industry utilization and economic benefit.

The first embodiment of the present invention has a main feature that two cams are connected serially with each other. One of the two cams is connected to a cushioning device, which achieves a cushioning function during a gear switching on the cam and shift fork, and avoids a gear disposition of the gear switching apparatus.

The second embodiment of the present invention a main feature that two cams are spaced apart and are connected and engaged serially with two ends of a connecting ring respectively for being driven simultaneously. A cushioning device is installed inside the connecting ring, which achieves a cushioning function during a gear switching on the cam and shift fork, and avoids a gear disposition of the gear switching apparatus.

The third embodiment of the present invention has a main feature that at least one cam is serially connected to a cushioning device, which achieves a cushioning function during a gear switching on the cam and shift fork, and avoids a gear disposition of the gear switching apparatus.

The structure of each of the first, second and third embodiments is provided in the following.

FIGS. 4 to 6 show the first embodiment of the present invention. In this embodiment, the camshaft assembly of the present invention comprises a driving shaft 1 which is capable of being electrically or manually driven to be rotated, a first spring adapting plate 10 integrated on the driving shaft 1, at least one cam 2 installed on the driving shaft 1, at least one shift fork 3 and a cushioning device 4. A number of the at least one shift fork 3 is identical to a number of the at least one cam 2. The at least one shift fork 3 is connected to the at least one cam 2 respectively. The at least one cam 2 includes a first cam 2A and a second cam 2B. The cushioning device 4 is operated at the first cam 2A and the spring adapting plate 10, which achieves a cushioning function for a gear switching on the at least one cam 2 and the at least one shift fork 3, and avoids a gear disposition of the gear switching apparatus.

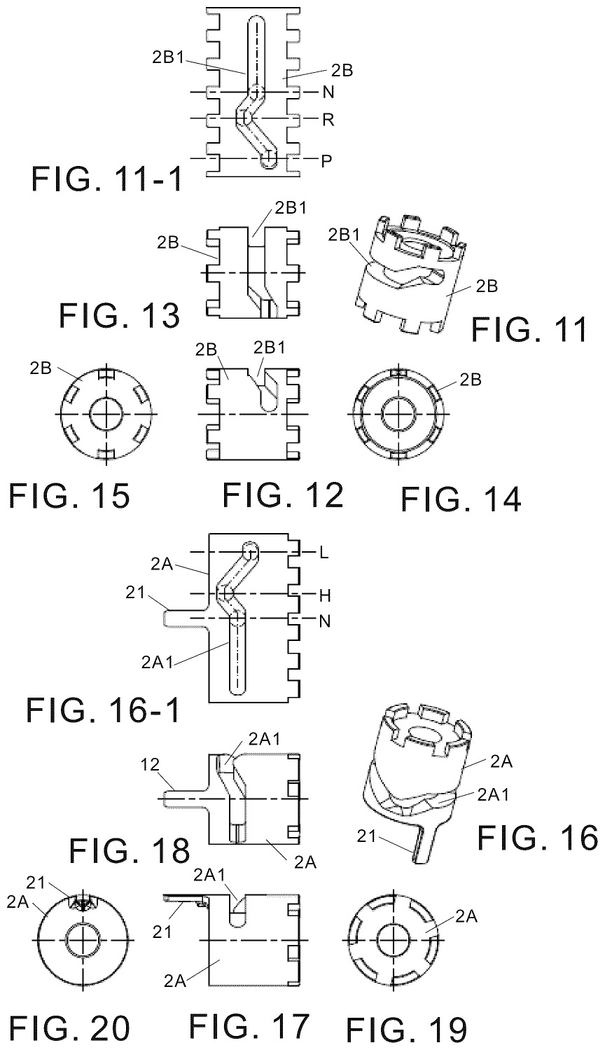

Referring to FIGS. 4 to 6, the cushioning device 4 is connected to a lower end of the first cam 2A (as shown in FIGS. 16 to 20). An upper end of the first cam 2A is engaged to a lower end of the second cam 2B, as shown in FIGS. 11 to 15. A fork shift guiding recess 2A1 is formed on a surface of the first cam 2A and has a single fixed inner width. A fork shift guiding recess 2B1 is formed on a surface of the second cam 2B and has a single fixed inner width. The fork shift guiding recess 2A1 of the first cam 2A and the fork shift guiding recess 2B1 of the second cam 2B serve to guide the at least one shift fork 3 to avoid the gear disposition of the gear switching apparatus. When the driving shaft 1 is rotated forward or reversely to perform a gear switching and the at least one shift fork 3 is in a gear misaligned state during a shifting of the at least one shift fork 3, the cushioning device 4 serves to provide a cushioning to cause that the first cam 2A and the second cam 2B generate a cushioning force for performing a gear alignment operating of the at least one shift fork 3, which achieves an auto gear aligning engagement and a gear cushioning switching on the first cam 2A, the second cam 2B and the at least one shift fork 3. Therefore, the gear disposition of the gear switching apparatus can be avoided.

The cushioning device 4 is installed on the lower end of the first cam 2A. A connecting rod 21 extends downwards from the lower end of the first cam 2A. The lower end of the first cam 2A is serially connected to an upper side of the first spring adapting plate 10 and the cushioning device 4 is serially connected to a lower side of the first spring adapting plate 10. The cushioning device 4 includes a spring supporting ring 41 having a hollow cylindrical structure and installed on the driving shaft 1, a spring cover 42 installed on a bottom end of the spring supporting ring 41, a spring supporting plate 43 installed between the lower side of the first spring adapting plate 10 and an upper end of a helical torsion spring 44. A resisting portion 411 protrudes out from an upper end of the spring supporting ring 41 and resists against an outer end of the first spring adapting plate 10. The helical torsion spring 44 surrounds an outer side of the spring supporting ring 41. A lower end of the helical torsion spring 44 is installed on the spring cover 42. An upper end of the helical torsion spring 44 is resisted against a protruded outer end of the spring supporting plate 43.

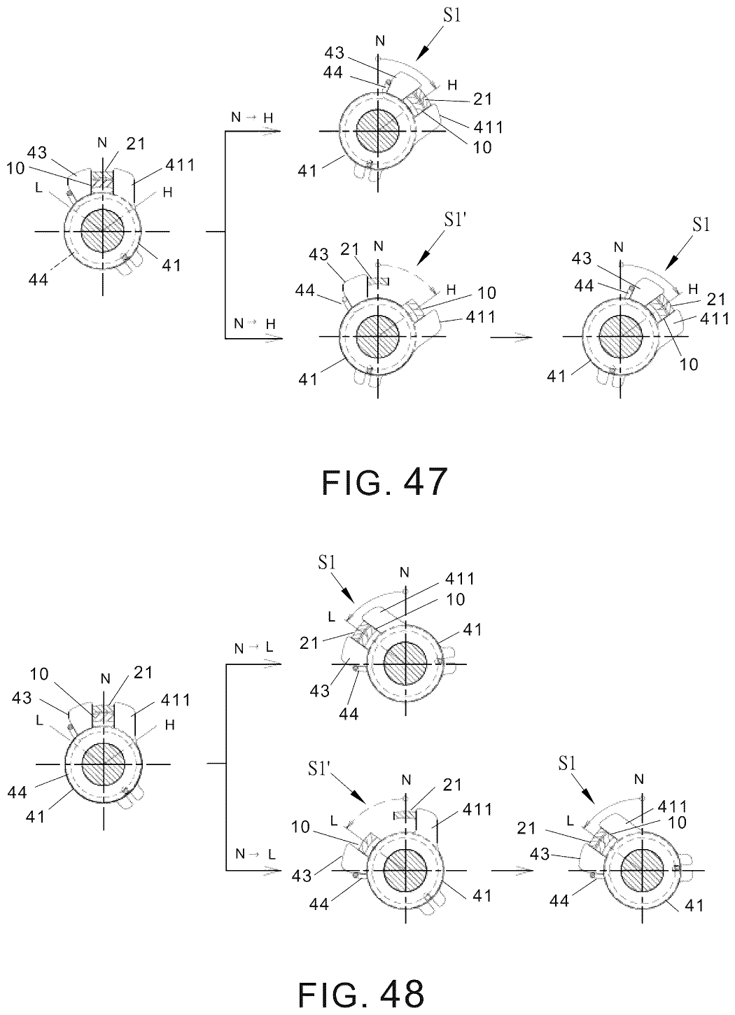

Referring to FIG. 47, the protruded outer end of the spring supporting plate 43 is resisted against between the upper end of the helical torsion spring 44 and the outer end of the first spring adapting plate 10. The outer end of the first spring adapting plate 10 is resisted against between the protruded outer end of the spring supporting plate 43 and the resisting portion 411 of the spring supporting ring 41. The connecting rod 21 is resisted by the resisting portion 411 and is located between the resisting portion 411 and the protruded outer end of the spring supporting plate 43.

FIGS. 4 to 6 and 47 to 48 show the application of the first embodiment. Referring to FIG. 47, when the driving shaft 1 is rotated forward to perform the gear switching by shifting from a neutral (N) gear positon to a high (H) gear position, the at least one shift fork 3 will be in a gear aligned state S1 or a gear misaligned state S1′ during the gear switching. In the gear aligned state S1, a shifting of the at least one shift fork 3 is not blocked and a reaction force is not generated and transmitted to the fork shift guiding recess 2A1 of the first cam 2A and the fork shift guiding recess 2B1 of the second cam 2B. A rotating of each of the first cam 2A, the second cam 2B, the spring supporting ring 41 and the helical torsion spring 44 is also not blocked and an accumulated pressure is not stored on the helical torsion spring 44. Therefore, the first spring adapting plate 10 simultaneously drives the spring supporting ring 41 to rotate and completes the gear alignment operating and the gear switching.

Referring to FIG. 47, when the at least one shift fork 3 is in the gear misaligned state S1′ during the gear switching, the shifting of the at least one shift fork 3 is blocked and the reaction force is generated and transmitted from the at least one shift fork 3 to the fork shift guiding recess 2A1 of the first cam 2A and the fork shift guiding recess 2B1 of the second cam 2B, which causes that the first spring adapting plate 10 is rotated and the outer end of the first spring adapting plate 10 rotates the spring supporting ring 41 and the spring cover 42 to drive the lower end of the helical torsion spring 44 to be rotated. The protruded outer end of the spring supporting plate 43 and the upper end of the helical torsion spring 44 are blocked by the connecting rod 21. Therefore, the spring supporting plate 43 and the upper end of the helical torsion spring 44 are not rotated, which causes that the accumulated pressure is generated and stored on the helical torsion spring 44 to generate a cushioning force to be applied on the at least one shift fork 3 in the gear misaligned state. When the at least one shift fork 3 is instantaneously shifted to change a state of the at least one shift fork 3 from the gear misaligned state S1′ to the gear aligned state S1, the accumulated pressure of the helical torsion spring 44 is instantaneously released to rotate the upper end of the helical torsion spring 44, the first cam 2A, the second cam 2B and the spring supporting plate 43, which completes the gear alignment operating and the gear switching with an instantaneous cushioning.

Referring to FIG. 48, when the driving shaft 1 is rotated reversely to perform the gear switching by shifting from a neutral (N) gear positon to a low (L) gear position, the at least one shift fork 3 will be in a gear aligned state S1 or a gear misaligned state S1′ during the gear switching. In the gear aligned state S1, a shifting of the at least one shift fork 3 is not blocked and a reaction force is not generated and transmitted to the fork shift guiding recess 2A1 of the first cam 2A. A rotating of each of the first cam 2A, the spring supporting ring 41 and the helical torsion spring 44 is also not blocked and an accumulated pressure is not stored on the helical torsion spring 44. Therefore, the first spring adapting plate 10 simultaneously drives the spring supporting ring 41, the spring supporting plate 43 and the helical torsion spring 44 to be rotated and completes the gear alignment operating and the gear switching on the first cam 2A and the at least one shift fork 3.

Referring to FIG. 48, when the at least one shift fork 3 are in the gear misaligned state S1′ during the gear switching, the shifting of the at least one shift fork 3 is blocked and the reaction force is generated and transmitted from the at least one shift fork 3 to the fork shift guiding recess 2A1 of the first cam 2A, which causes that the first spring adapting plate 10 is rotated and the outer end of the first spring adapting plate 10 rotates the spring supporting plate 43 and the upper end of the helical torsion spring 44. The resisting portion 411 is blocked by the connecting rod 21. Therefore, the spring supporting ring 41, the spring cover 42 and the lower end of the helical torsion spring 44 are not rotated, which causes that the accumulated pressure is generated and stored on the helical torsion spring 44 to generate a cushioning force to be applied on the at least one shift fork 3 in the gear misaligned state. When the at least one shift fork 3 is instantaneously shifted to change a state of the at least one shift fork 3 from the gear misaligned state S1′ to the gear aligned state S1, the accumulated pressure of the helical torsion spring 44 is instantaneously released to rotate the first cam 2A, the spring supporting ring 41, the spring cover 42 and the lower end of the helical torsion spring 44, which completes the gear alignment operating and the gear switching with an instantaneous cushioning.

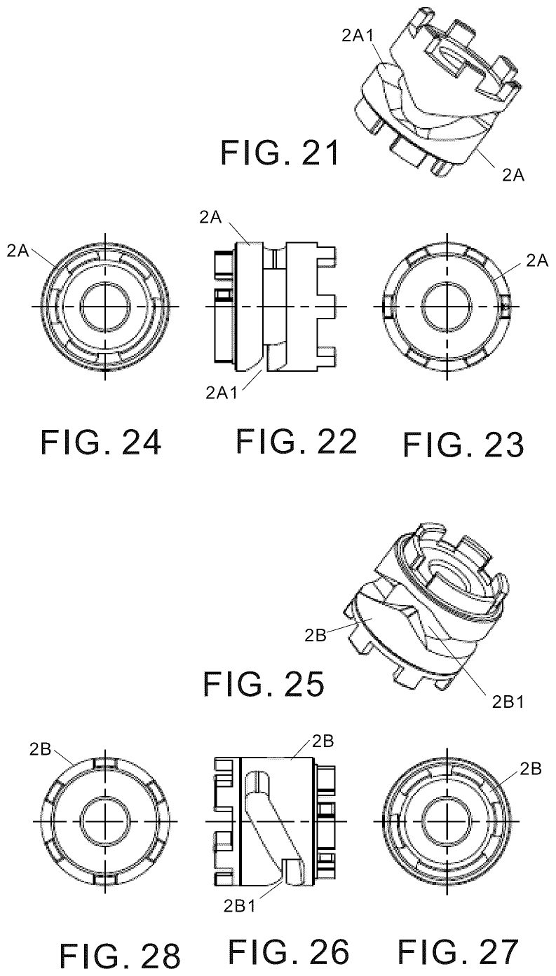

FIGS. 7, 8, 21 to 28, and 37 to 41 show the second embodiment of the present invention. In this embodiment, the camshaft assembly of the present invention comprises a driving shaft 1 which is capable of being electrically or manually driven to be rotated, a first spring adapting plate 10 integrated on the driving shaft 1, at least one cam 2, at least one shift fork 3, and a cushioning device 4. A number of the at least one shift fork 3 is identical to a number of the at least one cam 2. The at least one shift fork 3 is connected to the at least one cam 2 respectively. The at least one cam 2 includes a first cam 2A (as shown in FIGS. 21 to 24) and a second cam 2B (as shown in FIGS. 25 to 28). The cushioning device 4 is engaged between the first cam 2A and the second cam 2B. The function of the cushioning device 4 of the second embodiment is identical to that of the first embodiment. The cushioning device 4 includes a connecting ring 40 and a second spring adapting plate 401 in the connecting ring 40 for replacing the connecting rod 21 of the first embodiment.

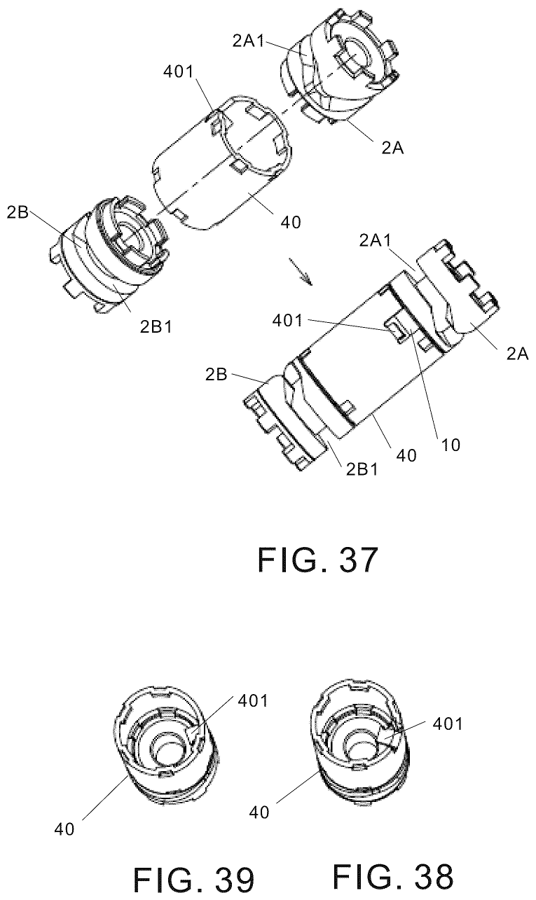

Referring to FIGS. 37 to 40, the connecting ring 40 is engaged between a lower end of the first cam 2A and an upper end the second cam 2B. The second spring adapting plate 401 is formed on an inner side of the connecting ring 40. The cushioning device 4 further includes a spring supporting ring 41 installed in the connecting ring 40 and serially installed on the driving shaft 1, a spacing ring 45 surrounding an outer side of the driving shaft 1, and a helical torsion spring 44 surrounding an outer side of the spacing ring 45. The helical torsion spring 44 is located in the spring supporting ring 41. An upper end of the helical torsion spring 44 resists against a first outer side of an outer end of the first spring adapting plate 10 and a first outer side the second spring adapting plate 401 which are at a same side. A lower end of the helical torsion spring 44 is connected to the spring supporting ring 41. Above structure serves to achieve a cushioning function during a gear switching on the at least one cam 2 and the at least one shift fork 3, and avoids a gear disposition of the gear switching apparatus.

The cushioning device 4 is installed between the first cam 2A and the second cam 2B and is interlocked to the first cam 2A and the second cam 2B through the connecting ring 40. A fork shift guiding recess 2A1 is formed on a surface of the first cam 2A and has a single fixed inner width. A fork shift guiding recess 2B1 is formed on a surface of the second cam 2B and has a single fixed inner width. The fork shift guiding recess 2A1 of the first cam 2A and the fork shift guiding recess 2B1 of the second cam 2B serve to guide the at least one shift fork 3 to avoid the gear disposition of the gear switching apparatus. When the driving shaft 1 is rotated forward or reversely to perform a gear switching and the at least one shift fork 3 are in a gear misaligned state during a shifting of the at least one shift fork 3, the cushioning device 4 serves to provide a cushioning to cause that the first cam 2A and the second cam 2B generate a cushioning force for performing a gear alignment operating of the at least one shift fork 3, which achieves an auto gear aligning engagement and a gear cushioning switching on the first cam 2A, the second cam 2B and the at least one shift fork 3. Therefore, the gear disposition of the gear switching apparatus can be avoided.

The spring supporting ring 41 has a hollow cylindrical structure. The spacing ring 45 is installed between the spring supporting ring 41 and the driving shaft 1. The helical torsion spring 44 is installed between the spring supporting ring 41 and the spacing ring 45.

The upper end of the helical torsion spring 44 is not fixed on the spring supporting ring 41. The upper end of the helical torsion spring 44 only resists against the first outer side of outer end of the first spring adapting plate 10 and the first outer side of the second spring adapting plate 401 which are at the same side. A resisting portion 411 protrudes out from an upper end of the spring supporting ring 41 and resists against a second outer side of the outer end of the first spring adapting plate 10 and a second outer side of the second spring adapting plate 401 which are at a same side. In an assembly state, the first spring adapting plate 10 and the second spring adapting plate 401 are not aligned and are not on a same cross section.

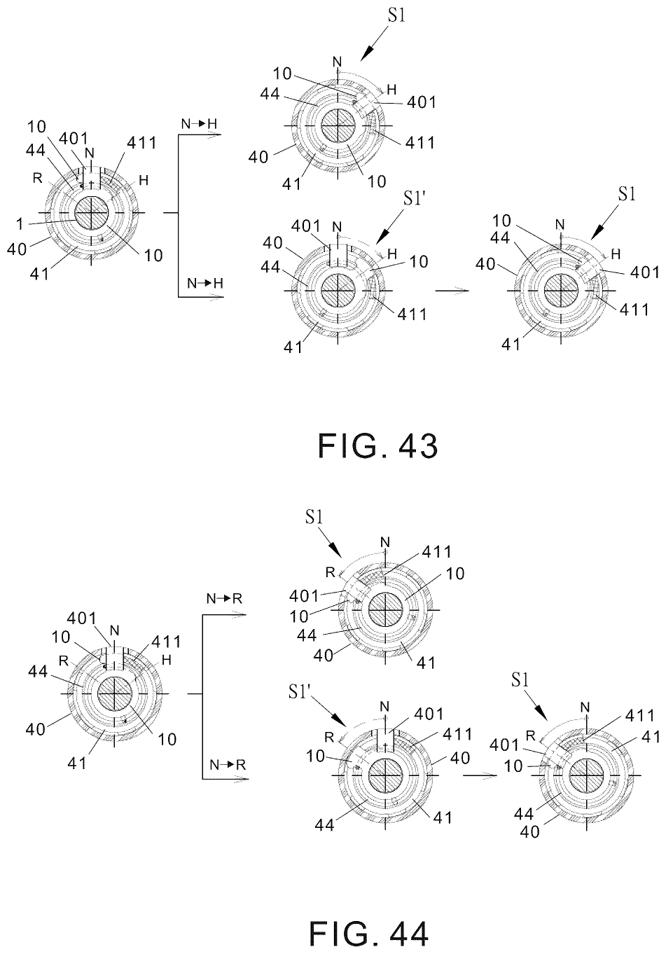

FIGS. 7 to 8 and 43 to 44 show the application of the second embodiment. Referring to FIG. 43, when the driving shaft 1 is rotated forward to perform the gear switching by shifting from a neutral (N) gear positon to a high (H) gear position, the at least one shift fork 3 will be in a gear aligned state S1 or a gear misaligned state S1′ during the gear switching. In the gear aligned state S1, a shifting of the at least one shift fork 3 is not blocked and a reaction force is not generated and transmitted to the fork shift guiding recess 2A1 of the first cam 2A and the fork shift guiding recess 2B1 of the second cam 2B. A rotating of each of the first cam 2A, the second cam 2B, the spring supporting ring 41 and the helical torsion spring 44 is also not blocked and an accumulated pressure is not stored on the helical torsion spring 44. Therefore, the first spring adapting plate 10 simultaneously drives the spring supporting ring 41 to rotate and completes the gear alignment operating and the gear switching.

Referring to FIG. 43, when the at least one shift fork 3 are in the gear misaligned state S1′ during the gear switching, the shifting of the at least one shift fork 3 is blocked and the reaction force is generated and transmitted from the at least one shift fork 3 to the fork shift guiding recess 2A1 of the first cam 2A and the fork shift guiding recess 2B1 of the second cam 2B, which causes that the first spring adapting plate 10 is rotated and the outer end of the first spring adapting plate 10 rotates the spring supporting ring 41 and the lower end of the helical torsion spring 44. The upper end of the helical torsion spring 44 is blocked by the second spring adapting plate 401 of the connecting ring 40. Therefore, the connecting ring 40 and the upper end of the helical torsion spring 44 are not rotated, which causes that the accumulated pressure is generated and stored on the helical torsion spring 44 to generate a cushioning force to be applied on the at least one shift fork 3 in the gear misaligned state. When the at least one shift fork 3 is instantaneously shifted to change a state of the at least one shift fork 3 from the gear misaligned state S1′ to the gear aligned state S1, the accumulated pressure of the helical torsion spring 44 is instantaneously released to rotate the connecting ring 40, the first cam 2A, the second cam 2B, the upper end of the helical torsion spring 44, which completes the gear alignment operating and the gear switching with an instantaneous cushioning.

Referring to FIG. 44, when the driving shaft 1 is rotated reversely to perform the gear switching by shifting from a neutral (N) gear positon to a reverse (R) gear position, the at least one shift fork 3 will be in a gear aligned state S1 or a gear misaligned state S1′ during the gear switching. In the gear aligned state S1, a shifting of the at least one shift fork 3 is not blocked and a reaction force is not generated and transmitted to the fork shift guiding recess 2A1 of the first cam 2A and the fork shift guiding recess 2B1 of the second cam 2B. A rotating of each of the first cam 2A, the spring supporting ring 41 and the helical torsion spring 44 is also not blocked and an accumulated pressure is not stored on the helical torsion spring 44. Therefore, the first spring adapting plate 10 and the second spring adapting plate 401 are rotated simultaneously to drive the spring supporting ring 41 to be rotated and complete the gear alignment operating and the gear switching.

Referring to FIG. 44, when the at least one shift fork 3 are in the gear misaligned state S1′ during the gear switching, the shifting of the at least one shift fork 3 is blocked and the reaction force is generated and transmitted from the at least one shift fork 3 to the fork shift guiding recess 2A1 of the first cam 2A and the fork shift guiding recess 2B1 of the second cam 2B, which causes that the first spring adapting plate 10 is rotated and the outer end of the first spring adapting plate 10 rotates the upper end of the helical torsion spring 44. The resisting portion 411 is blocked by the second spring adapting plate 401 of the connecting ring 40. Therefore, the spring supporting ring 41 and the lower end of the spring supporting ring 41 are not rotated, which causes that the accumulated pressure is generated and stored on the helical torsion spring 44 to generate a cushioning force to be applied on the at least one shift fork 3 in the gear misaligned state. When the at least one shift fork 3 is instantaneously shifted to change a state of the at least one shift fork 3 from the gear misaligned state S1′ to the gear aligned state S1, the accumulated pressure of the helical torsion spring 44 is instantaneously released to rotate the connecting ring 40, the first cam 2A, the second cam 2B, the spring supporting ring 41, and the lower end of the helical torsion spring 44, which completes the gear alignment operating and the gear switching with an instantaneous cushioning.

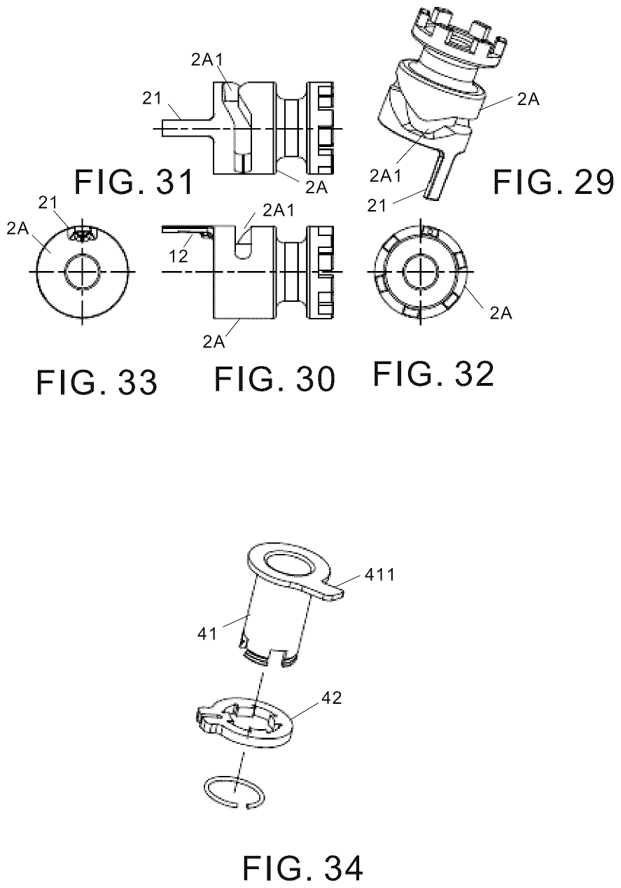

FIGS. 9 to 10 show the third embodiment of the present invention. The difference between the first and third embodiment is only that the at least one cam 2 in the first embodiment is replaced with at least one cam 2A (as shown in FIGS. 29 to 33) in the third embodiment, remaining elements of the third embodiment is identical to those of the first embodiment. In the third embodiment, the camshaft assembly of the present invention comprises a driving shaft 1 which is capable of being electrically or manually driven to be rotated, a first spring adapting plate 10 integrated on the driving shaft 1, at least one first cam 2A, at least one shift fork 3 and a cushioning device 4. A number of the at least one shift fork 3 is identical to a number of the at least one first cam 2A. The at least one shift fork 3 is connected to the at least one first cam 2A respectively. The cushioning device 4 is operated at the at least one first cam 2A and the spring adapting plate 10, which achieves a cushioning function for a gear switching on the at least one first cam 2A and the at least one shift fork 3, and avoids a gear disposition of the gear switching apparatus. A first cam 2A and a shift fork 3 are used as examples in the following description.

Referring to FIGS. 9 to 10, the cushioning device 4 is connected to a lower end of the first cam 2A. A fork shift guiding recess 2A1 is formed on a surface of the first cam 2A and has a single fixed inner width. The fork shift guiding recess 2A1 of the first cam 2A serves to guide the respective shift fork 3 to avoid the gear disposition of the gear switching apparatus. When the driving shaft 1 is rotated forward or reversely to perform a gear switching and the at least one shift fork 3 are in a gear misaligned state during a shifting of the at least one shift fork 3, the cushioning device 4 serves to provide a cushioning to cause that the first cam 2A generates a cushioning force for performing a gear alignment operating of the at least one shift fork 3, which achieves an auto gear aligning engagement and a gear cushioning switching on the first cam 2A and the at least one shift fork 3. Therefore, the gear disposition of the gear switching apparatus can be avoided.

The cushioning device 4 is installed on the lower end of the first cam 2A. A connecting rod 21 extends downwards from the lower end of the first cam 2A. The lower end of the first cam 2A is serially connected to an upper side of the first spring adapting plate 10 and the cushioning device 4 is serially connected to a lower side of the first spring adapting plate 10. The cushioning device 4 includes a spring supporting ring 41 having a hollow cylindrical structure and installed on the driving shaft 1, a spring cover 42 installed on a bottom end of the spring supporting ring 41, a spring supporting plate 43 installed between the lower side of the first spring adapting plate 10 and an upper end of a helical torsion spring 44. A resisting portion 411 protrudes out from an upper end of the spring supporting ring 41 and resists against an outer end of the first spring adapting plate 10. The helical torsion spring 44 surrounds an outer side of the spring supporting ring 41. A lower end of the helical torsion spring 44 is installed on the spring cover 42. An upper end of the helical torsion spring 44 is resisted against a protruded outer end of the spring supporting plate 43.

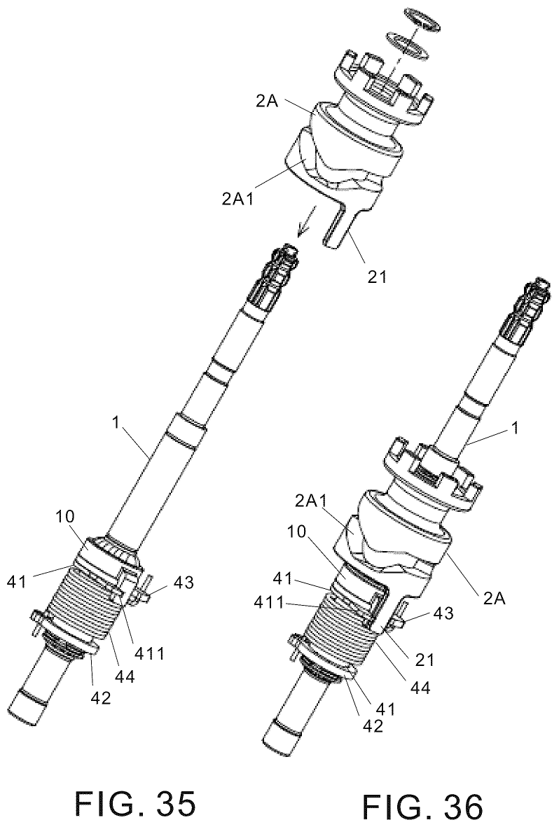

Referring to FIGS. 35 to 36, the protruded outer end of the spring supporting plate 43 is resisted against between the upper end of the helical torsion spring 44 and the outer end of the first spring adapting plate 10. The outer end of the first spring adapting plate 10 is resisted against between the protruded outer end of the spring supporting plate 43 and the resisting portion 411 of the spring supporting ring 41. The connecting rod 21 is resisted by the resisting portion 411 and is located between the resisting portion 411 and the protruded outer end of the spring supporting plate 43.

FIGS. 9 to 10 and 47 to 48 show the application of the third embodiment. FIGS. 47 and 48 are suitable for the applications of both first and third embodiment. Referring to FIG. 47, when the driving shaft 1 is rotated forward to perform the gear switching by shifting from a neutral (N) gear positon to a high (H) gear position, the at least one shift fork 3 will be in a gear aligned state S1 or a gear misaligned state S1′ during the gear switching. In the gear aligned state S1, a shifting of the at least one shift fork 3 is not blocked and a reaction force is not generated and transmitted to the fork shift guiding recess 2A1 of the first cam 2A. A rotating of each of the first cam 2A, the spring supporting ring 41 and the helical torsion spring 44 is also not blocked and an accumulated pressure is not stored on the helical torsion spring 44. Therefore, the first spring adapting plate 10 simultaneously drives the spring supporting ring 41 to rotate and completes the gear alignment operating and the gear switching.

Referring to FIG. 47, when the at least one shift fork 3 is in the gear misaligned state S1′ during the gear switching, the shifting of the at least one shift fork 3 is blocked and the reaction force is generated and transmitted from the at least one shift fork 3 to the fork shift guiding recess 2A1 of the first cam 2A, which causes that the first spring adapting plate 10 is rotated and the outer end of the first spring adapting plate 10 rotates the spring supporting ring 41 and the spring cover 42 to drive the lower end of the helical torsion spring 44 to be rotated. The protruded outer end of the spring supporting plate 43 and the upper end of the helical torsion spring 44 are blocked by the connecting rod 21. Therefore, the spring supporting plate 43 and the upper end of the helical torsion spring 44 are not rotated, which causes that the accumulated pressure is generated and stored on the helical torsion spring 44 to generate a cushioning force to be applied on the at least one shift fork 3 in the gear misaligned state. When the at least one shift fork 3 is instantaneously shifted to change a state of the at least one shift fork 3 from the gear misaligned state S1′ to the gear aligned state S1, the accumulated pressure of the helical torsion spring 44 is instantaneously released to rotate the upper end of the helical torsion spring 44, the first cam 2A and the spring supporting plate 43, which completes the gear alignment operating and the gear switching with an instantaneous cushioning.

Referring to FIG. 48, when the driving shaft 1 is rotated reversely to perform the gear switching by shifting from a neutral (N) gear positon to a low (L) gear position, the at least one shift fork 3 will be in a gear aligned state S1 or a gear misaligned state S1′ during the gear switching. In the gear aligned state S1, a shifting of the at least one shift fork 3 is not blocked and a reaction force is not generated and transmitted to the fork shift guiding recess 2A1 of the first cam 2A. A rotating of each of the first cam 2A, the spring supporting ring 41 and the helical torsion spring 44 is also not blocked and an accumulated pressure is not stored on the helical torsion spring 44. Therefore, the first spring adapting plate 10 simultaneously drives the spring supporting ring 41, the spring supporting plate 43 and the helical torsion spring 44 to be rotated and completes the gear alignment operating and the gear switching on the first cam 2A and the at least one shift fork 3.

Referring to FIG. 48, when the at least one shift fork 3 is in the gear misaligned state S1′ during the gear switching, the shifting of the at least one shift fork 3 is blocked and the reaction force is generated and transmitted from the at least one shift fork 3 to the fork shift guiding recess 2A1 of the first cam 2A, which causes that the first spring adapting plate 10 is rotated and the outer end of the first spring adapting plate 10 rotates the spring supporting plate 43 and the upper end of the helical torsion spring 44. The resisting portion 411 is blocked by the connecting rod 21. Therefore, the spring supporting ring 41, the spring cover 42 and the lower end of the helical torsion spring 44 are not rotated, which causes that the accumulated pressure is generated and stored on the helical torsion spring 44 to generate a cushioning force to be applied on the at least one shift fork 3 in the gear misaligned state. When the at least one shift fork 3 is instantaneously shifted to change a state of the at least one shift fork 3 from the gear misaligned state S1′ to the gear aligned state S1, the accumulated pressure of the helical torsion spring 44 is instantaneously released to rotate the first cam 2A, the spring supporting ring 41, the spring cover 42 and the lower end of the helical torsion spring 44, which completes the gear alignment operating and the gear switching with an instantaneous cushioning.

The present invention has the following advantages:
(1) The present invention provides at least one cam for controlling the shifting of at least one shift fork. The cam has a fork shift guiding recess having a fixed inner width for guiding the respective shift fork to avoid the gear disposition during the shifting of the fork shift and to eliminate the serious danger of the vehicle sliding on its own due to forceful gear disposition.
(2) The present invention provides the at least one cam which is engaged to each other and is not opened or closed. The cam is connected to a single cushioning device which serves to provide a cushioning performance during the gear misaligned state of the shift fork. The design of using one single cushioning device reduces the complexity of the cushioning function and solves the disadvantage of the prior cushioning device using a complex design of multiple cushioning springs.
(3) The present invention provides the at least one cam which is engaged to and spaced apart from each other and is not opened or closed. The cushioning device is installed between two cams and has a connecting ring engaged between the two cams, which provides a cushioning function during the gear misaligned state of the shift fork and solves the disadvantage of the prior cushioning device using a complex design of multiple cushioning springs.
(4) The present invention provides a camshaft assembly for the gear switching apparatus of the vehicle with a simple structure, fewer components, a low cost, a compact size and a good practicability.
(5) The present invention provides a camshaft assembly for the gear switching apparatus of the vehicle with a high safety, a high practicality, a high industrial utilization and a high economically efficiency.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A camshaft assembly for a gear switching apparatus of a vehicle comprising:
a driving shaft (1) capable of being electrically or manually driven to be rotated;
a first spring adapting plate (10) integrated on the driving shaft (1);
at least one cam (2) installed on the driving shaft (1); a fork shift guiding recess formed on a surface of each of the at least one cam (2) and having a single fixed inner width; the fork shift guiding recess serving to guide the at least one shift fork (3) to avoid a gear disposition of the gear switching apparatus;
at least one shift fork (3) connected to the at least one cam (2);
a cushioning device (4) installed between the driving shaft (1) and the at least one cam (2); and
wherein when the driving shaft (1) is rotated forward or reversely to perform a gear switching and the at least one shift fork (3) is in a gear misaligned state during a shifting of the at least one shift fork (3), the cushioning device (4) serves to provide a cushioning to cause that the at least one cam (2) and first spring adapting plate (10) generate a cushioning force for performing a gear alignment operating of the at least one shift fork (3), which achieves an auto gear aligning engagement and a gear cushioning switching on the at least one cam (2) and the at least one shift fork (3) to avoid the gear disposition of the gear switching apparatus.

2. (canceled)

3. (canceled)

4. The camshaft assembly for the gear switching apparatus of the vehicle as claimed in claim 1, wherein the at least one cam (2) includes a first cam (2A) connected to the respective shift fork (3); and the cushioning device (4) is installed between the first cam and the driving shaft (1).

5. (canceled)

6. (canceled)

7. (canceled)

8. (canceled)

9. (canceled)

10. (canceled)

11. (canceled)

12. (canceled)

13. The camshaft assembly for the gear switching apparatus of the vehicle as claimed in claim 1, wherein the first spring adapting plate (10) integrated on the driving shaft (1); a number of the at least one shift fork (3) is identical to a number of the at least one cam (2); the at least one shift fork (3) is connected to the at least one cam (2) respectively; the at least one cam (2) includes a first cam (2A); the cushioning device (4) is operated at the first cam (2A) and the spring adapting plate (10);
wherein the cushioning device (4) is connected to a lower end of the first cam (2A); a fork shift guiding recess (2A1) is formed on a surface of the first cam (2A) and has a single fixed inner width; the fork shift guiding recess (2A1) of the first cam (2A) serves to guide the respective shift fork (3) to avoid the gear disposition of the gear switching apparatus;
wherein a connecting rod (21) extends downwards from the lower end of the first cam (2A); the lower end of the first cam (2A) is serially connected to an upper side of the first spring adapting plate (10) and the cushioning device (4) is serially connected to a lower side of the first spring adapting plate (10); and
wherein the cushioning device (4) includes a spring supporting ring (41) having a hollow cylindrical structure and installed on the driving shaft (1), a spring cover (42) installed on a bottom end of the spring supporting ring (41), a spring supporting plate (43) installed between the lower side of the first spring adapting plate (10) and an upper end of a helical torsion spring (44); a resisting portion (411) protrudes out from an upper end of the spring supporting ring (41) and resists against an outer end of the first spring adapting plate (10); the helical torsion spring (44) surrounds an outer side of the spring supporting ring (41); a lower end of the helical torsion spring (44) is installed on the spring cover (42); an upper end of the helical torsion spring (44) is resisted against a protruded outer end of the spring supporting plate (43).

14. The camshaft assembly for the gear switching apparatus of the vehicle as claimed in claim 13, wherein the protruded outer end of the spring supporting plate (43) is resisted against between the upper end of the helical torsion spring (44) and the outer end of the first spring adapting plate (10); the outer end of the first spring adapting plate (10) is resisted against between the protruded outer end of the spring supporting plate (43) and the resisting portion (411) of the spring supporting ring (41); the connecting rod (21) is resisted by the resisting portion (411) and is located between the resisting portion (411) and the protruded outer end of the spring supporting plate (43).

15. The camshaft assembly for the gear switching apparatus of the vehicle as claimed in claim 4, wherein the first spring adapting plate (10) integrated on the driving shaft (1); a number of the at least one shift fork (3) is identical to a number of the at least one cam (2); the at least one shift fork (3) is connected to the at least one cam (2) respectively; the cushioning device (4) is operated at the first cam (2A) and the spring adapting plate (10);
wherein the cushioning device (4) is connected to a lower end of the first cam (2A); a fork shift guiding recess (2A1) is formed on a surface of the first cam (2A) and has a single fixed inner width; the fork shift guiding recess (2A1) of the first cam (2A) serves to guide the respective shift fork (3) to avoid the gear disposition of the gear switching apparatus;
wherein a connecting rod (21) extends downwards from the lower end of the first cam (2A); the lower end of the first cam (2A) is serially connected to an upper side of the first spring adapting plate (10) and the cushioning device (4) is serially connected to a lower side of the first spring adapting plate (10); and
wherein the cushioning device (4) includes a spring supporting ring (41) having a hollow cylindrical structure and installed on the driving shaft (1), a spring cover (42) installed on a bottom end of the spring supporting ring (41), a spring supporting plate (43) installed between the lower side of the first spring adapting plate (10) and an upper end of a helical torsion spring (44); a resisting portion (411) protrudes out from an upper end of the spring supporting ring (41) and resists against an outer end of the first spring adapting plate (10); the helical torsion spring (44) surrounds an outer side of the spring supporting ring (41); a lower end of the helical torsion spring (44) is installed on the spring cover (42); an upper end of the helical torsion spring (44) is resisted against a protruded outer end of the spring supporting plate (43).

16. The camshaft assembly for the gear switching apparatus of the vehicle as claimed in claim 15, wherein the protruded outer end of the spring supporting plate (43) is resisted against between the upper end of the helical torsion spring (44) and the outer end of the first spring adapting plate (10); the outer end of the first spring adapting plate (10) is resisted against between the protruded outer end of the spring supporting plate (43) and the resisting portion (411) of the spring supporting ring (41); the connecting rod (21) is resisted by the resisting portion (411) and is located between the resisting portion (411) and the protruded outer end of the spring supporting plate (43).
